(19) United States
(12) Patent Application Publication
(10) Pub. No.: US 2013/0241722 A1
(43) Pub. Date: Sep. 19, 2013

(54) Kit for Controlling a Commercial Trucks Lights Wirelessly

(71) Applicant: Yoel Martinez, Miami, FL (US)

(72) Inventor: Yoel Martinez, Miami, FL (US)

(21) Appl. No.: 13/420,607

(22) Filed: Mar. 15, 2012

(51) Int. Cl. G08C 17/02; B60Q 1/30

(52) U.S. Cl. 340/438

(57) ABSTRACT

A digital RF Kit used to control the lights of a commercial truck. The digital RF Kit comprises of a digital master RF device that is housed in a cabin of a commercial vehicle (the commercial vehicle has a front and rear side and it has a DC electrical system and a transmission), at least one front digital RF device that is positioned in the front of the vehicle that communicates with the digital master RF device and at least one front light of the vehicle, at least one rear digital RF device that is positioned in the rear of the vehicle that communicates with the digital master RF device and at least one rear light of the vehicle, and a transmission RF device that is connected to the vehicles transmission so that when the vehicle is placed in reverse, a signal is transmitted to the digital master RF device.

### BACKGROUND

The present invention is directed to a kit for controlling a commercial truck's lights wirelessly.

The inventor of the present invention repairs the wiring of commercial trucks for a living. During his years as a commercial truck electrician, he noticed that after a period of years, the exterior lights of commercial trucks brought their owners many problems. Problems arose because the lights or the wiring leading to the lights of the trucks fail with time. The failure of the wiring in turn leads to accidents, down time with regards to the operation of the trucks, and tickets that may arise because of the non-operation of the lights.

Truck operators normally change blown lights themselves, yet many times, the blown lights don't address the underlying problem. The underlying problem being that the wires or leading to the lights are either worn or are shorting with other wires.

Commercial trucks inherently have many wires connecting their lights to their commercial truck cabins. In turn, this leads to significant down time when a short in the wiring system has to be identified. Many times, when a light is blown, a short is difficult to discover and the truck has to be taken apart to discover the short.

The present invention addresses the problem of having unnecessary wires entering the cabin of a truck. By addressing this problem, the time that a truck is down is minimized. This way a truck cabin does not have to be taken apart to discover a short. The invention also addresses how to easily find shorts in commercial truck wiring systems by providing RF devices that serve to provide power to lights and that are relatively close to the RF devices. The RF devices connect to a digital master RF device. The digital master RF device is programmed to receive, transmit, and analyze the signals of the RF devices. The RF devices provide a mechanism that easily identities the light or wiring that has led to the blown light. The mechanism uses an LED indicator that lights up when a short occurs in the RF device.

For the foregoing reasons, there is a need for a kit for controlling a commercial truck's lights wirelessly that will minimize the cabling normally involved in the wiring of lights from a commercial truck's cabin to its exterior lights and will also allow the operator of the vehicle or an electrician working on vehicle to identify lights that are out or wires that may be causing a short.

### SUMMARY

The present invention is directed to a kit for controlling a commercial truck's lights wirelessly that minimizes the cabling involved in the wiring of lights from a commercial truck's cabin to its exterior lights. The invention also allows an operator of the vehicle or an electrician working on the vehicle to identify lights that are out or wires that may be causing a short.

The present invention is a digital RF Kit that is used to control the lights of a commercial truck, the digital RF Kit comprises of a digital master RF device that is housed in a cabin of a commercial vehicle, the commercial vehicle has a front and rear side and it has a DC electrical system and a transmission. The digital RF kit further comprises at least one front digital RF device that is positioned in the front of the vehicle that communicates with the digital master RF device and at least one front light of the vehicle. The digital RF kit further comprises of at least one rear digital RF device that is positioned in the rear of the vehicle that communicates with the digital master RF device and at least one rear light of the vehicle. The digital RF kit further comprises of a transmission RF device that is connected to the vehicles transmission so that when the vehicle is placed in reverse, a signal is transmitted to the digital master RF device.

An object of the present invention is to minimize the cabling normally associated with the wiring of a commercial truck vehicles lights that stem from the cab of the commercial vehicle.

Another object of the present invention is to minimize the time normally associated with the labor involved when diagnosing and repairing the lighting electrical system of a commercial truck.

A further object of the present invention is to allow the operator of a vehicle to easily identify a problem with the vehicles lighting system.

A further object of the present invention is to allow an electrician working on a vehicle to easily identify a problem with the vehicles lighting system or wiring.

Yet another object of the present invention is to reduce the costs normally endured by the owner of the commercial vehicle when having the truck's electrical lighting system maintained.

### DRAWINGS

These and other features, aspects, and advantages of the present invention will become better understood with regard to the following description, appended claims, and drawings where:

FIG. 1 shows a side view of the kit of the present invention mounted on a commercial truck vehicle;

FIG. 2 shows a front view of the digital master RF device of the present invention within a cab of a commercial vehicle;

FIG. 3 shows a front view of the front digital RF and the battery powered RF device of the present invention mounted on a commercial truck vehicle;

FIG. 4 shows a rear view of the rear digital RF device and the 7-pin RF device of the present invention mounted on a commercial truck vehicle; and

FIG. 5 shows a top view of the transmission RF device of the present invention.

### DESCRIPTION

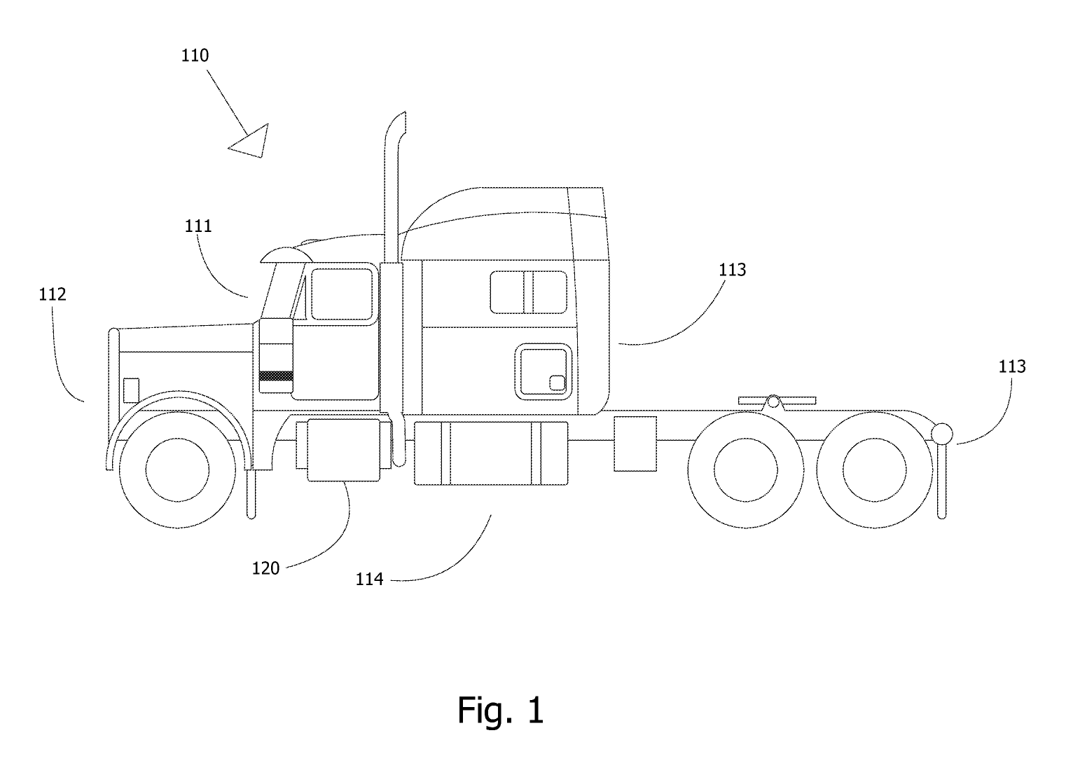

As seen if FIGS. 1-5, a digital RF Kit that is used to control the lights of a commercial truck 110, the digital RF Kit comprises of a digital master RF device 10 that is housed in a cabin 111 of a commercial vehicle 110, the commercial vehicle 110 has a front 112 and rear side 113 and it has a DC electrical system 120 and a transmission 40. The digital RF fit further comprises at least one front digital RF device 20 that is positioned in the front of the vehicle 112 that communicates with the digital master RF device 10 and at least one front light 24.a of the vehicle 110. The digital RF kit further comprises of at least one rear digital RF device 30 that is positioned in the rear 113 of the vehicle 110 that communicates with the digital master RF device 10 and at least one rear light 34.a of the vehicle, The digital RF kit further comprises of a transmission RF device 40 that is connected to the vehicles transmission 114 so that when the vehicle 110 is placed in reverse, a signal is transmitted to the digital master RF device 10.

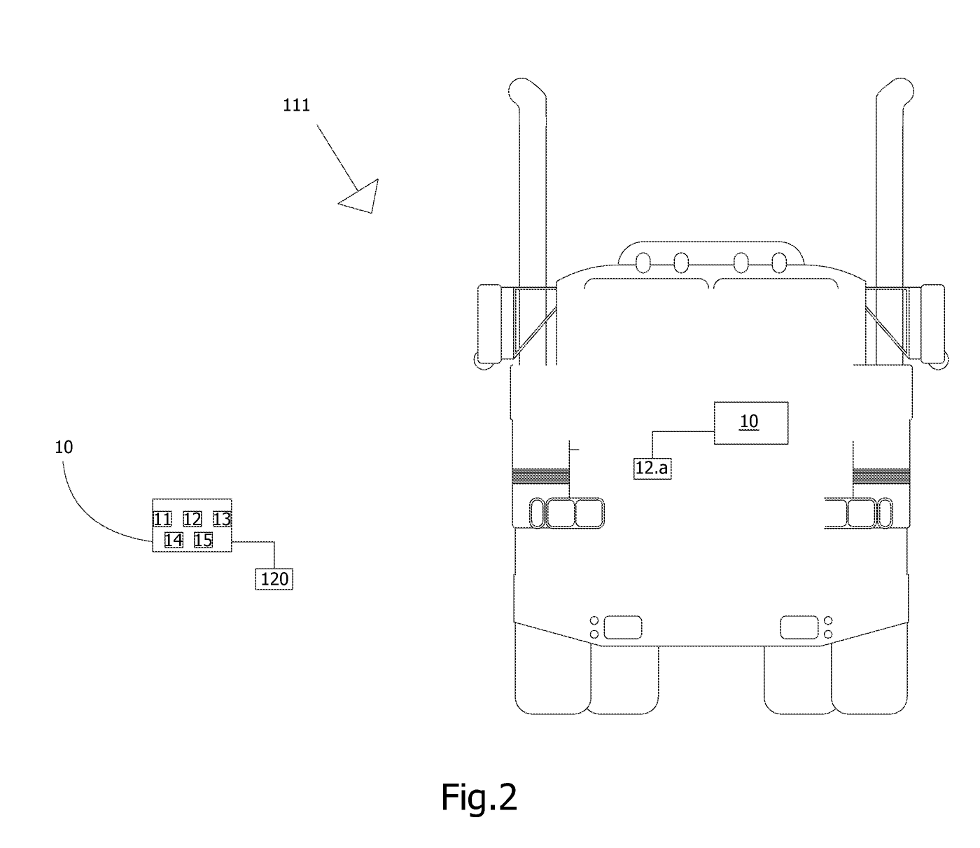

As seen in FIG. 2, the digital master RF device 10 comprises of a master power input 11, the master power input 11 connects to the DC electrical system 120 of the commercial vehicle 110; at least one analog receiver 12 that connects to an analog signal 12.a; a master RF transmitter 13; a master RF receiver 14; and a master processor 15 connected to the master RF transmitter 13 and the master RF receiver 14, the master processor 15 connects to the master power input 11. The digital master RF device 10 is programmed to communicate, send, receive and analyze signals received from all devices of the kit. It would alert the operator of the commercial truck that a problem has occurred with regards to the vehicles lighting system. It would alert the operator of the vehicle of where the problem has been identified and it would indicate which device is sending the signal. The digital master RF device's analog receiver 12 connects to switches, turn signals, and/or brakes controls of the commercial vehicle 110 via hard wire.

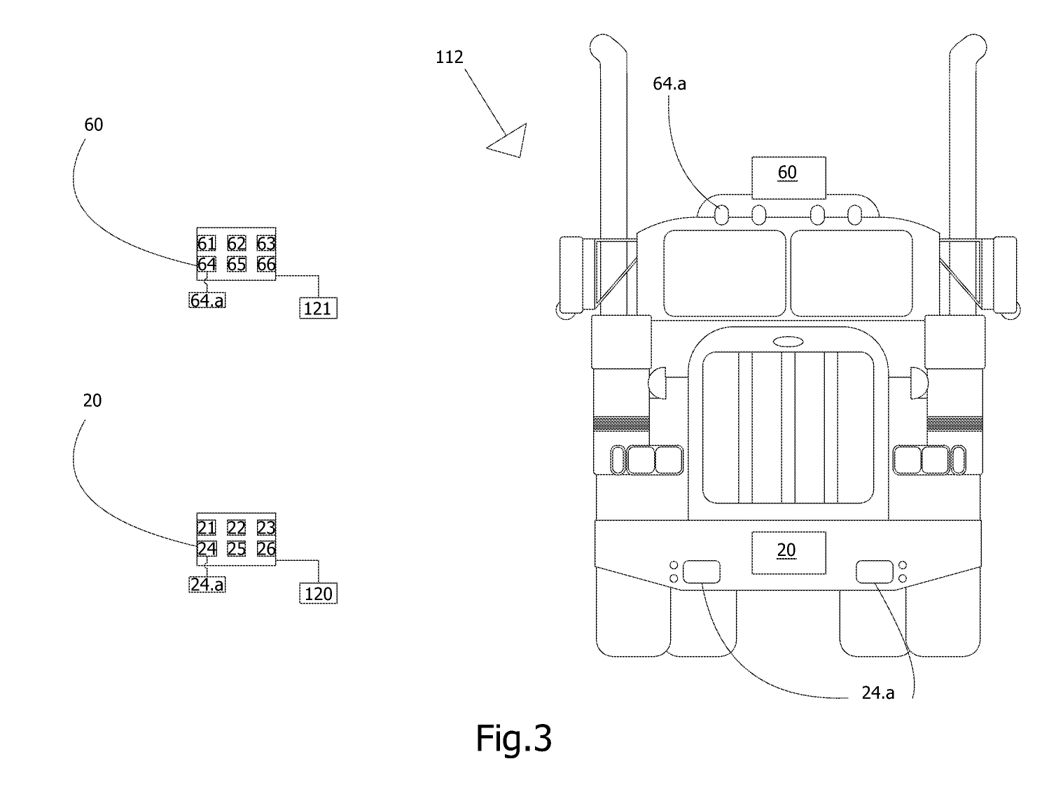

As seen in FIG. 3, at least one front digital RF device 20 that is positioned in the front of the vehicle 112 that communicates with the digital master RF device 10 and at least one front light 24.a of the vehicle, each front digital RF device comprises 20 of a front power input 21, each front power input 21 connects to the DC electrical system 120 of the commercial vehicle 110; an RF front receiver 22; an RF front transmitter 23; an RF front processor 25 connected to the RF front transmitter 23 and the RF front receiver 22, the RF front processor 25 connects to the front power input 21; at least one front power output 24; and at least one front LED light 26, each front LED light 26 is connected each front power output 24 so that if a problem arises with regards to any front power output 24 each front LED light 26 would turn on and a signal would be transmitted to the digital master RF device 10 from the front digital RF device 20. Any front LED light turned on would instruct the driver as to which specific light is connected to each specific front power output experiencing a broken loop, thereby allowing the driver to easily identify the problem with any light and minimizing the length of cabling between a commercial vehicle's power source and the light.

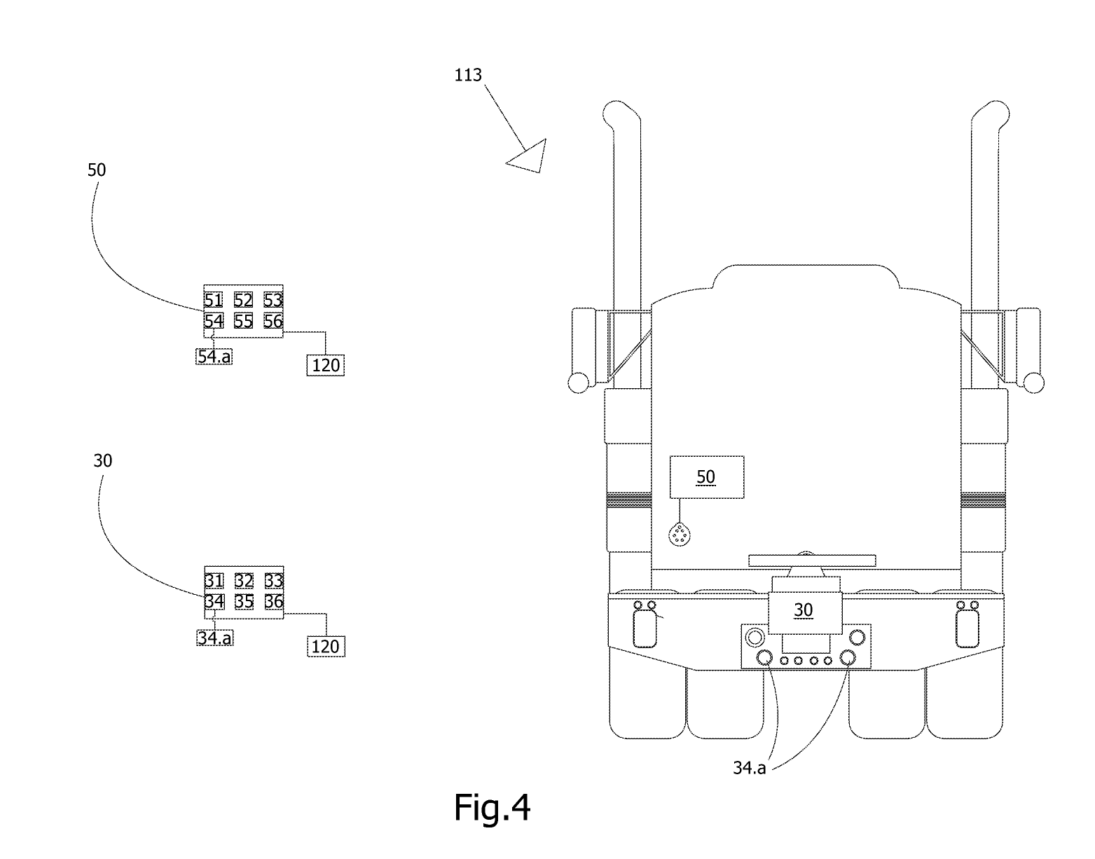

As seen in FIG. 4, each rear digital device 30 comprises of a rear power input 31, the power input 31 connects to the DC electrical system 120 of the commercial vehicle 110; an RF rear receiver 32; an RF rear transmitter 33; an RF rear processor 35 connected to the RF rear transmitter 33 and the RF rear receiver 32, the RF rear processor 35 connects to the rear power input 31; at least one rear power output 34; and at least one rear LED light 36, each rear LED light 36 is connected each rear power output 34 so that if a problem arises with regards to the rear power output 34 each rear LED light 36 would turn on and a signal would be transmitted to the digital master RF device 10 from the rear digital RF device 30. Any rear LED light 36 turned on would instruct the driver as to which specific light is connected to each specific rear power output experiencing a broken loop, thereby allowing the driver to easily identify the problem with any light and minimizing the length of cabling between a commercial vehicle's power source and the light.

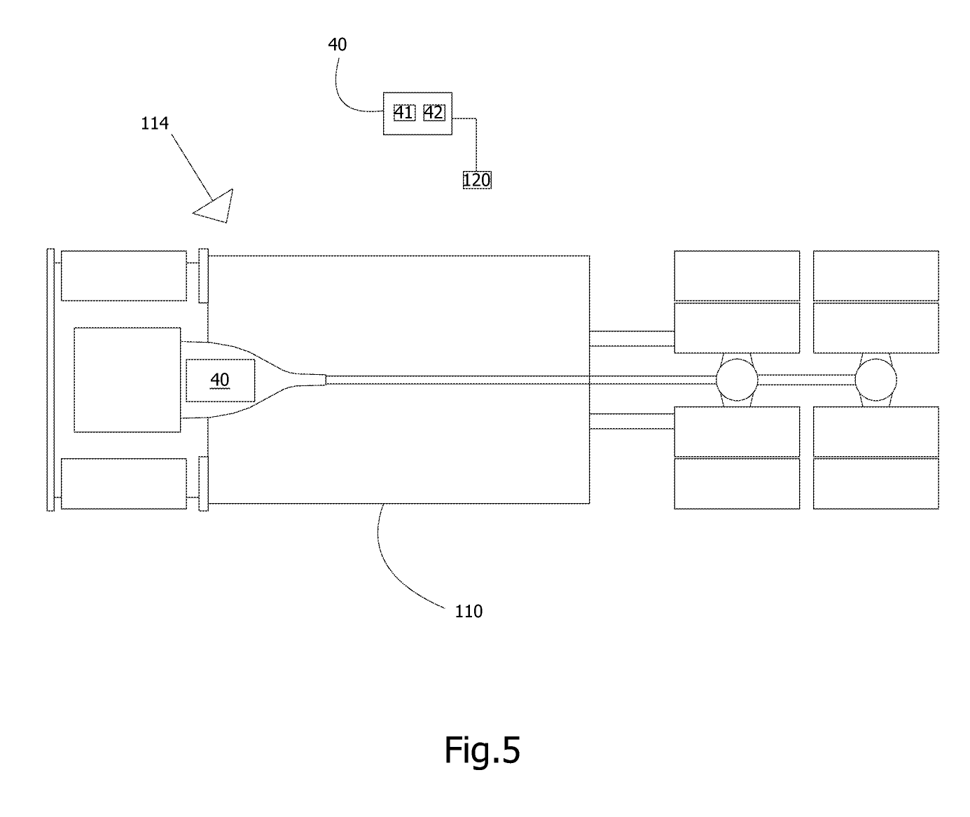

As seen in FIG. 5, the transmission RF device comprises 40 of a transmitter power input 41, the transmitter power input 41 connects to the DC electrical system 120 of the commercial vehicle 110; and an RF rear transmitter 42 that communicates with the digital master RF device 10. The transmission RF device 40 works in tandem with the digital master RF device 10 to turn reverse lights of the commercial vehicle 110 on when the vehicles transmission is placed in reverse position.

As seen in FIGS. 1 and 4, in another embodiment of the present invention, the digital RF Kit described above further comprises of a 7-pin RF device 50, the 7-pin RF device 50 connects to a commercial truck trailer (not shown in figures), the 7-pin RF device 50 comprises of a 7-pin power input 51, the 7-pin power input 51 connects to the DC electrical system 120 of the commercial vehicle 110; a 7-pin receiver 52; a 7-pin transmitter 53; a 7-pin processor 55 connected to the 7-pin receiver 52 and the 7-pin transmitter 53, the 7-pin processor 55 connects to the 7-pin power input 51; at least one 7-pin power output 54; and at least one 7-pin LED light 56, each 7-pin LED light 56 is connected each 7-pin power output 54 so that if a problem arises with regards to the 7-pin power output 54, the LED light 56 would turn on and a signal would be transmitted to the digital master RF device 10 from the 7-pin RF device 50.

As seen in FIGS. 1 and 3, in a further embodiment of the present invention, the digital RF Kit described above might further comprise of a battery powered RF device 60, the battery powered RF device 60 comprises of a battery power input 61 connected to a battery source 121; a battery powered receiver 62; a battery powered transmitter 63; a battery powered processor 65 connected to the battery powered receiver 62 and the battery powered transmitter 63; at least one battery powered power output 64; and at least one battery powered LED light 66, each battery powered LED light 66 is connected each battery powered power output 64 so that if a problem arises with regards to the battery powered power output 64, the LED light 66 would turn on and a signal would be transmitted to the digital master RF device 10 from the battery powered RF device 60, The battery powered RF device 60 connects to a cabin light 64.a.

An advantage of the present invention is that it minimizes the cabling normally associated with the wiring of a commercial truck vehicles lights that stem from the cab of the commercial vehicle.

Another advantage of the present invention is that it minimizes the time normally associated with the labor involved when diagnosing and repairing the lighting electrical system of a commercial truck.

A further advantage of the present invention is that it allows the operator of a vehicle to easily identify a problem with the vehicles lighting system.

A further advantage of the present invention is that it allows an electrician working on a vehicle to easily identify a problem with the vehicles lighting system or wiring.

Yet another advantage of the present invention is that it reduces the costs normally endured by the owner of the commercial vehicle when having the truck's electrical lighting system maintained.

Although the present invention has been described in considerable detail in reference to preferred versions, other versions are possible. Therefore, the spirit and scope of the appended claims should not be limited to the description of the preferred versions contained herein.

What is claimed is:

1. A digital RF Kit that is used to control the lights of a commercial truck, the digital RF Kit comprises:
a digital master RF device that is housed in a cabin of a commercial vehicle, the commercial vehicle has a front and rear side and it has a DC electrical system and a transmission, the digital RF device comprises,
a master power input, the master power input connects to the DC electrical system of the commercial vehicle;
at least one analog receiver that connects to an analog signal;
a master RF transmitter;
a master RF receiver; and
a master processor connected to the master RF transmitter and the master RF receiver, the master processor connects to the master power input;
at least one front digital RF device that is positioned in the front of the vehicle that communicates with the digital master RF device and at least one front light of the vehicle, each front digital RF device comprises,
a front power input, each front power input connects to the DC electrical system of the commercial vehicle;
an RF front receiver;
an RF front transmitter;
an RF front processor connected to the RF front transmitter and the RF front receiver, the RF front processor connects to the front power input;
at least one front power output; and
at least one front LED light, each front LED light is connected each front power output so that if a problem arises with regards to the front power output each front LED light would turn on and a signal would be transmitted to the digital master RF device from the front digital RF device;
at least one rear digital RF device that is positioned in the rear of the vehicle that communicates with the digital master RF device and at least one rear light of the vehicle, each rear digital RF device comprises,
a rear power input, the power input connects to the DC electrical system of the commercial vehicle;
an RF rear receiver;
an RF rear transmitter;
an RF rear processor connected to the RF rear transmitter and the RF rear receiver, the RF rear processor connects to the rear power input;
at least one rear power output; and
at least one rear LED light, each rear LED light is connected each rear power output so that if a problem arises with regards to the rear power output each rear LED light would turn on and a signal would be transmitted to the digital master RF device from the rear digital RF device; and
a transmission RF device that is connected to the vehicles transmission so that when the vehicle is placed in reverse, a signal is transmitted to the digital master RF device, the transmission RF device comprises,
a transmitter power input, the transmitter power input connects to the DC electrical system of the commercial vehicle; and
an RF rear transmitter that communicates with the digital master RF device.

2. The digital RF Kit that is used to control the lights of a commercial truck of claim 1, the digital RF Kit further comprises of a 7-pin RF device, the 7-pin RF device connects to a commercial truck trailer, the 7-pin RF device comprises:
a 7-pin power input, the 7-pin power input connects to the DC electrical system of the commercial vehicle;
a 7-pin receiver;
a 7-pin transmitter;
a 7-pin processor connected to the 7-pin receiver and the 7-pin transmitter, the 7-pin processor connects to the 7-pin power input;
at least one 7-pin power output; and
at least one 7-pin LED light, each 7-pin LED light is connected each 7-pin power output so that if a problem arises with regards to the 7-pin power output any 7-pin LED light would turn on and a signal would be transmitted to the digital master RF device from the 7-pin RF device.

3. The digital RF Kit that is used to control the lights of a commercial truck of claim 2, the digital RF Kit further comprises of a battery powered RF device, the battery powered RF device connects to a cabin light, the battery powered RF device comprises:
a battery power input connected to a battery source;
a battery powered receiver;
a battery powered transmitter;
a battery powered processor connected to the battery powered receiver and the battery powered;
at least one battery powered power output; and
at least one battery powered LED light, each battery powered LED light is connected each battery powered power output so that if a problem arises with regards to the battery powered power output any battery powered LED light would turn on and a signal would be transmitted to the digital master RF device from the battery powered RF device.

4. The digital RF Kit that is used to control the lights of a commercial truck of claim 1, the digital RF Kit further comprises of a battery powered RF device, the battery powered RF device connects to a cabin light, the battery powered RF device comprises:
a battery power input connected to a battery source;
a battery powered receiver;
a battery powered transmitter;
a battery powered processor connected to the battery powered receiver and the battery powered transmitter;
at least one battery powered power output; and
at least one battery powered LED light, each battery powered LED light is connected each battery powered power output so that if a problem arises with regards to the battery powered power output each battery powered LED light would turn on and a signal would be transmitted to the digital master RF device from the battery powered RF device.
